(19) United States
(12) Patent Application Publication
(10) Pub. No.: US 2012/0124857 A1
(43) Pub. Date: May 24, 2012

(54) ALIGNMENT FILM DRYING DEVICE AND DRYING METHOD

(75) Inventors: CHENGMING HE, SHENZHEN (CN); MAOCHENG YAN, SHENZHEN (CN); HSIANG-YIN SHIH, SHENZHEN (CN)

(73) Assignee: Shenzhen China Star Optoelectronics Technology Co., LTD., Shenzhen City (CN)

(21) Appl. No.: 13/219,688

(22) Filed: Aug. 28, 2011

(30) Foreign Application Priority Data
Nov. 22, 2010 (CN) 201010557504.5

(51) Int. Cl. F26B 13/10; F26B 3/02; F26B 3/34

(52) U.S. Cl. 34/444; 34/612; 34/273

(57) ABSTRACT

The present invention provides an alignment film drying device and drying method thereof for drying alignment film material, which is diluted with solvent and formed on a first surface of a substrate. The device comprises a heating stage, heating a second surface of the substrate and comprising a plurality of pores averagely distributed thereon; a peripheral supporting mechanism, being located at the periphery of the heating stage to support edges of the second surface; a plurality of support pins, being averagely distributed on an upper surface of the heating stage; and an elevator mechanism, raising and lowering the peripheral supporting mechanism and the support pins. The present invention can eliminate the phenomenon of drying alignment film unevenly in the drying process to optimize the alignment film quality for raising the display characteristic of the LCD (Liquid Crystal Display) panel and raising the quality and yield of the LCD panel.

### BACKGROUND OF THE INVENTION

1. Field of the Invention

The present invention generally relates to a LCD (Liquid Crystal Display) skill technology, and more particularly to an alignment film drying device and a drying method thereof.

2. Description of Prior Art

With the continuous development of electrooptical technology and semiconductor technology, the LCD (Liquid Crystal Display) has been widely applied in kinds of field in society. Generally, the LCD main body mainly comprises two glass substrates and the LC layer located between the two glass substrates. At present, TFT (Thin Film Transistor) is the major product in all LCDs. The manufacture of the TFT LCD is generally divided as three parts: manufacture of patterns on the two glass substrates, LC seal between the two glass substrates to form a LCD unit (cell) and assembly of LCD units into LCM (Liquid Crystal Module). For saving cost and realizing product diversification, there is not only one LCD unit on the glass substrate but many LCD units arranged like a chessboard on the glass substrate. As the different models and sizes of products, the number and the arrangement of the LCD units on the glass substrate will be different. The LCD units on the glass substrate are cut into each single LCD unit after the LC seal is completed.

In the manufacture of sealing LC between two glass substrates to form A LCD unit, the LCD area (display area, other area is named non-display area below) of the two glass substrates are respectively configured with an alignment film. After the rub procedure, the alignment film configured on the display area of the substrate generate the alignment ability and therefore, alignment function acts to the LC layer to arrange the LC aligned along a regular direction.

The steps of forming the alignment film comprises (1) coating step, alignment film diluted with solvent formed on the substrate by print and other skills; (2) drying step, evaporating the solvent and the alignment film distributed evenly is left with the temperature about 100 degrees C.; (3) roasting step, solidifying the alignment film with the temperature above 180 degrees C. In drying step, the substrate is directly put on the hot plate for heating in general. As shown in FIG. 1, the simple drying process is that the robot places the substrate 100 on the support pins 110. The support pins 110 are lowered in the accommodation holes 120 to put the substrate 100 on the hot plate 140 heated by the heater 130 for heating and drying. After drying, the support pins 110 are raised to lift the substrate 100. The robot conveys the substrate 100; besides, the China publication patent No. CN1423159 also discloses a manufacture method and drying device of a LCD assembly. The patent utilizes warm air for drying. As shown in FIG. 2, the simple drying process is that the robot places the substrate 200 on the support pins 210. The soaking container 200 is above the substrate and stores the warm air heated by the heater 230. The warm air is blown onto the surface of the substrate through the nozzles 240. After drying, the robot conveys the substrate. Mentioning either of the aforementioned drying methods, the drying process is performed to the alignment film on the surface of the substrate directly and the same drawback exists. That is, as the accommodation holes 120 or the support pin 210 at fixed positions contact the display areas of the substrate, the heating rate at the contact points and the heating rate at other areas of the display area are not identical. The alignment film has drying difference in the drying process and becomes uneven. Therefore, effect occurs to the LC alignment at the surface of the alignment film. Finally, the bad display characteristic of the LCD panel occurs and the quality and yield of the LCD panel become lower.

### SUMMARY OF THE INVENTION

An objective of the present invention is to provide an alignment film drying device to eliminate the phenomenon of drying alignment film unevenly in the drying process to optimize the alignment film quality for raising the display characteristic of the LCD panel and raising the quality and yield of the LCD panel.

For realizing the aforesaid objective, the present invention employs the under technical solution:

An alignment film drying device, used for drying alignment film material, which is diluted with solvent and formed on a first surface of a substrate, comprising:

a heating stage, heating a second surface of the substrate and comprising a plurality of pores averagely distributed thereon;

a peripheral supporting mechanism, being located at the periphery of the heating stage to support edges of the second surface;

a plurality of support pins, being averagely distributed on an upper surface of the heating stage; and

an elevator mechanism, raising and lowering the peripheral supporting mechanism and the support pins.

Preferably, the peripheral supporting mechanism comprises a plurality of supporting claws parallelly located to the heating stage and the peripheral supporting mechanism supports the edges of the second surface of the substrate with the supporting claws.

In one embodiment of the present invention, the alignment film drying device further comprises an exhaust unit, and upward or downward exhaust directions, an exhaust time and a displacement of the exhaust unit are adjustable.

In one embodiment of the present invention, the heating stage comprises a first heat-conducting layer, a first insulation layer, a heating layer and a second insulation layer from top to bottom in sequence.

Preferably, a pitch between adjacent pores is 1˜10 mm.

Preferably, the pores are vertically opened in the first heat-conducting layer, and an air flow channel is formed in the interior of the first heat-conducting layer, and each of the pores is connected to the air flow channel.

Preferably, the heating stage further comprises a second heat-conducting layer and the second heat-conducting layer located under the second insulation layer.

Preferably, the first heat-conducting layer is an aluminum plate.

Preferably, the heating layer is divided into a certain number of different-temperature subareas. The number of the different-temperature subareas is larger than or equal to one.

In one embodiment of the present invention, the first and second insulation layers are utilizing insulation material. The insulation material comprises mica.

In one embodiment of the present invention, the first and second heat-conducting layers are utilizing heat-conducting material. The heat-conducting material comprises aluminum.

In one embodiment of the present invention, the surfaces of the first and the second heat-conducting layers are coated with black re-electrolyte material. The black re-electrolyte material can transform the heat on the heating stage into infrared ray. The infrared ray can be absorbed by the substrate and turns into heat for heating the substrate.

In one embodiment of the present invention, the first surface of the substrate comprises display areas. The alignment film material diluted with solvent is formed on the display areas. The number of the display areas on each substrate is six.

An objective of the present invention is to provide an alignment film drying method.

For realizing the aforesaid objective, the present invention employs the under technical solution:

An alignment film drying method, utilizing in the aforesaid alignment film drying device, comprising steps of:

(a) providing the substrate, having the first surface which alignment film material diluted with solvent is thereon, and putting the substrate on the support pins reaching the second substrate of the substrate;

(b) lowering the support pins supporting the substrate to a first preset position;

(c) blowing heated air from the pores of the heating stage and raising the peripheral supporting mechanism at the same time to support the edges of the second surface of the substrate;

(d) lowering the support pins to a second preset position;

(e) drying the alignment film material diluted with solvent on the first surface of the substrate; and

(f) raising the support pins up to reach the second surface of the substrate and stopping blowing the heated air from the pores for finishing the drying process.

Preferably, the spacing between the support pins and the heating stage is 2˜7 mm as the support pins are at the first preset position; the spacing between the support pins and the heating stage is 1˜7 mm as the support pins are at the second preset position.

Preferably, in step (c), the pores 311a of the heating stage 310 blow heated air to make the substrate 360 floated away from the support pins 350 to minus the effect of the support pins 350 as drying the alignment film in advance.

Preferably, in step (e), a time of drying the alignment film material is 1˜3 min and a temperature of drying the alignment film material is 80˜150 degrees C.

In one embodiment of the present invention, the alignment film drying method further comprises an exhausting step (i) which is intermittently executed in step (e).

In one embodiment of the present invention, the alignment film drying method further comprises an exhausting step (i) which is constantly executed in step (e).

In one embodiment of the present invention, the alignment film material is polyimide.

The beneficial effect of the present invention is to make the alignment film area part of the substrate floated in the air without contact of any matter by blowing heated air to the second surface of the substrate, to avoid the alignment film area to be contacted with the support pins and results in that the alignment film becomes uneven after drying. The present invention can make the substrate heated evenly in the drying process. The present invention can volatilize the solvent in the solvent-diluted alignment film material, such as the solvent in PI (Polyimide) rapidly and evenly. Then, the alignment film which is even and has stable quality can be formed on the substrate to make the liquid crystal in respective areas obtain an even alignment force for raising the display characteristic of the LCD panel and raising the quality and yield of the LCD panel.

### BRIEF DESCRIPTION OF THE DRAWINGS

FIG. 1 shows a structure diagram of a heating plate drying device according to prior art.

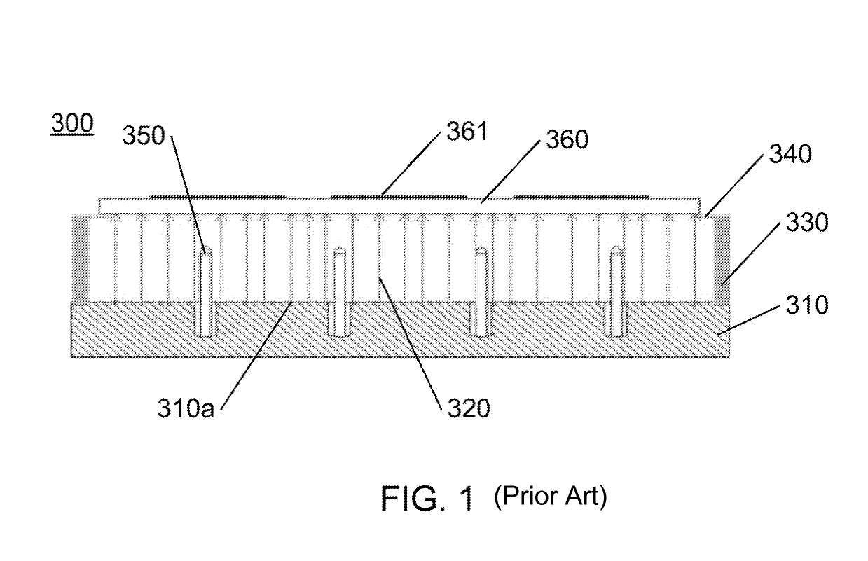

FIG. 2 shows a structure diagram of a warm air drying device according to prior art.

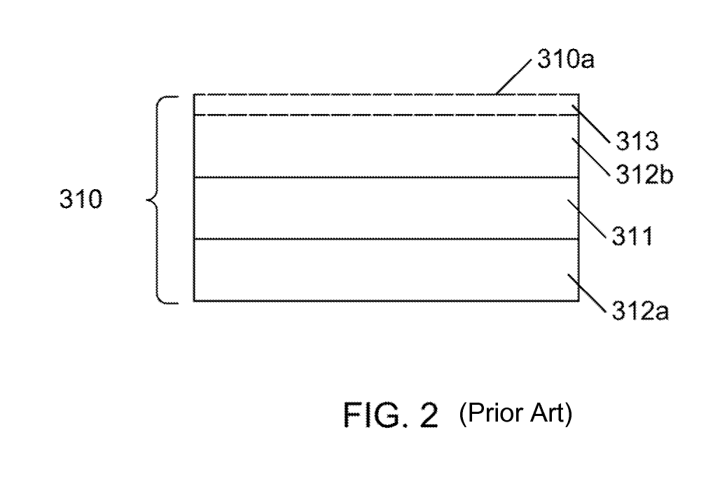

FIG. 3 shows a structure diagram of an alignment film drying device according to the present invention.

FIG. 4 shows a sectional view structure diagram of a heating stage according to the specific embodiment of the present invention.

FIG. 5 shows a top view diagram of the heating stage according to the specific embodiment of the present invention.

FIG. 6 shows a flowchart of the specific embodiment of the present invention.

### DETAILED DESCRIPTION OF THE INVENTION

For a better understanding the aforementioned content of the present invention, preferable embodiments are illustrated in conjunction with the attached figures for further explanation:

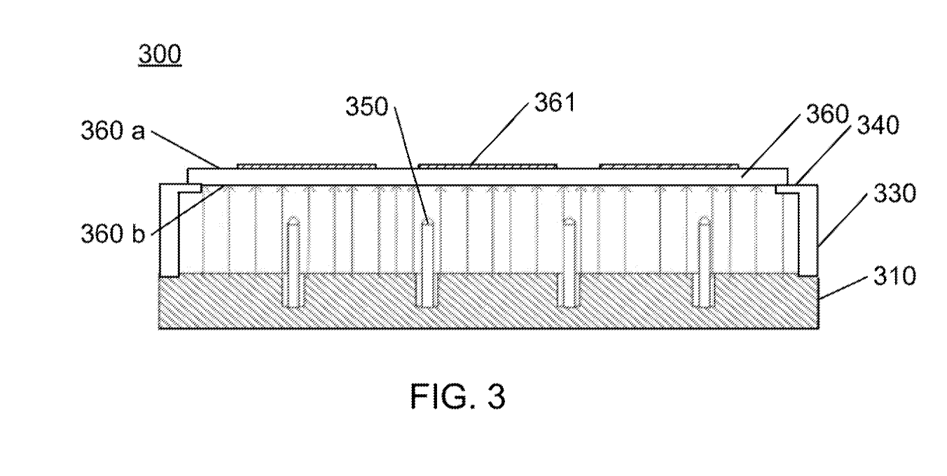

Please refer to FIG. 3, which shows a structure diagram of an alignment film drying device according to the present invention. The alignment film drying device 300 is used for drying alignment film material, which is diluted with solvent and formed on a first surface 360a (the upper surface) of a substrate 360. The alignment film drying device 300 comprises a heating stage 310, heating a second surface 360b (the lower surface) of the substrate 360 and heating stage 310 comprises a plurality of pores averagely distributed thereon; a peripheral supporting mechanism 330, being located at the periphery of the heating stage 310. In this specific embodiment, the peripheral supporting mechanism 330 comprises a plurality of supporting claws 340 to supports the edges of the second surface 360b of the substrate 360 with the supporting claws 340. In other embodiments, the structure of the peripheral supporting mechanism 330 is not limited therewith; a plurality of support pins 350, being averagely distributed on the heating stage 310; and an elevator mechanism (not shown), raising and lowering the peripheral supporting mechanism 330 and the support pins 350.

In this specific embodiment, the size of the substrate 360 is 1300 mm×1100 mm×0.7 mm but not limited thereto. The substrate 360 comprises display areas 361. The alignment film material diluted with solvent is formed on the display areas 361. Each substrate can comprise a plurality of display areas on the first surface 360a and the number of the display areas on each substrate is preferably six. The PI (Polyimide) diluted with solvent is coated on the display areas 361 as being the alignment film material.

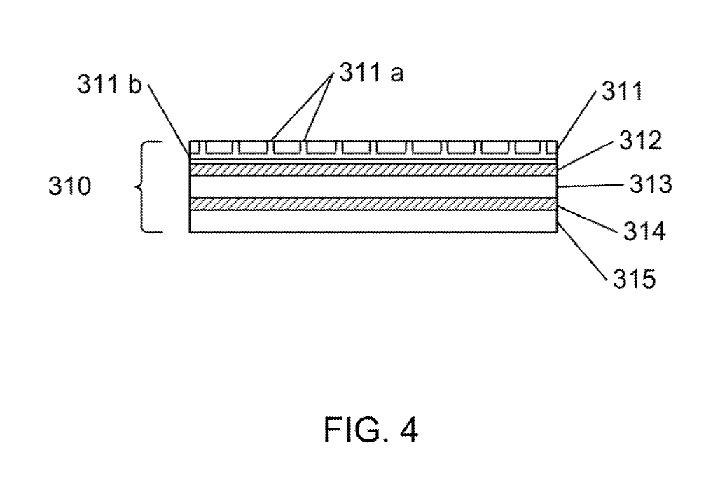

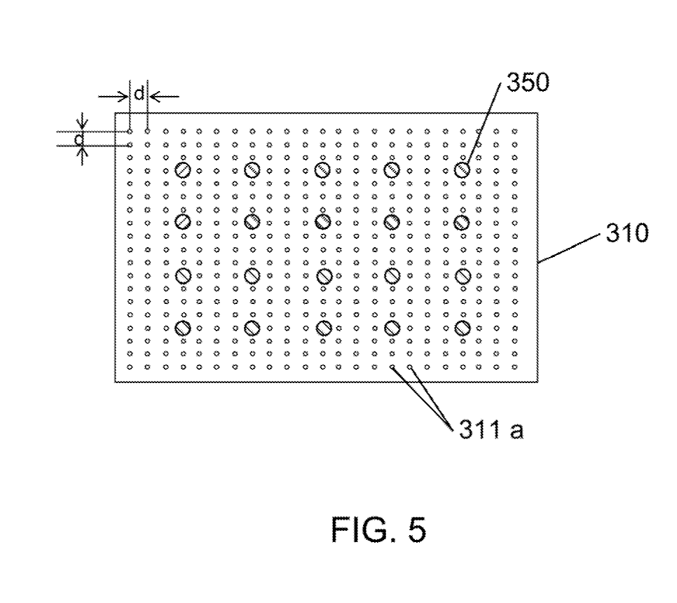

Please refer to FIG. 4 and FIG. 5. FIG. 4 and FIG. 5 show a sectional view structure diagram and a top view diagram of a heating stage according to one specific embodiment of the present invention. In the specific embodiment, the heating stage 310 comprises a first heat-conducting layer 311, a first insulation layer 312, a heating layer 313, a second insulation layer 314 and a second heat-conducting layer 315 from top to bottom in sequence. The pores 311a are vertically opened in the first heat-conducting layer 311. A pitch d between adjacent pores is 1˜10 mm. An air flow channel 311b is formed in the interior of the first heat-conducting layer 311, and each of the pores 311a is connected to the air flow channel 311b.

The structure of the heating stage 310 is not limited to the structure, either. In other embodiments, the second heat-conducting layer 315 can be omitted for example. In this specific embodiment, the function of locating the second heat-conducting layer 315 is when several heating stages 310 stack up for drying the alignment films of several substrates 360 at the same time, the second heat-conducting layer 315 of the upper heating stage 310 can downwardly heat the substrate 360 on the heating stages 310 thereunder when the upper heating stage 310 heats the substrate 360 thereon to raise heating efficiency and save heat energy.

Considering the heat aggregation effect of the heating stage 310 occurred during the heating process, the temperature at the center of the heating stage 310 could be little more higher than that at the edges of the heating stage 310 and causes alignment film material on the surface of the substrate 360 to be heated unevenly. The heating layer 313 can be divided into a certain number of different-temperature subareas according to the temperature differences. The number of the different-temperature subareas is larger than or equal to one. Different types and different amounts can be chosen for respective different-temperature subareas to heat the center and the edges evenly.

In this specific embodiment, the first and second insulation layers 312, 314 are utilizing insulation material comprising mica; the first and second heat-conducting layers 311, 315 are utilizing heat-conducting material comprising aluminum; the heating layer 313 is utilizing heater strips. In practical applications, the materials are not limited to the aforementioned illustrations.

Furthermore, the surfaces of the first and the second heat-conducting layer 311, 315 can be coated with black re-electrolyte material. The black re-electrolyte material can transform the heat on the heating stage 310 into infrared ray. The infrared ray can be absorbed by the substrate 360 and turns into heat for heating the substrate 360. Meanwhile, the coating material can function to protect the surface of the heating stage 310 and to prevent the surface of the heating stage 310 cracked and the happened particles.

The air flow channel 311b in the interior of the first heat-conducting layer 311 is connected to the pores 311a. As the heating stage 310 needs to generate heated air, CDA (Clean Dry Air) is employed as being a gas source to be inlet into the air flow channel 311b and to be blown out from the pores 311a. Specifically, the pores 311a are densely distributed on the heating stage 310. The CDA is preheated by the preheating unit (not shown) before passing through the pores 311a to be blown out from the pores 311a to form a heated air flow 320 with uniform temperature vertically upwards. The temperature regulations of the heating layer 313 of the heating stage 310 and the preheating unit for the CDA are proceeded by a temperature control system (not shown) to maintain the temperatures of the surface of the heating stage 310 and the heated air flow 320 within 80˜150 degrees C.

The peripheral supporting mechanism 330 of the present invention can be manufactured by mineral material or organic material. The peripheral supporting mechanism 330 is installed at the periphery of the heating stage 310, and raised and lowered by the elevator mechanism (not shown); in this specific embodiment, the peripheral supporting mechanism 330 comprises a plurality of supporting claws 340. The supporting claws 340 are parallelly to the heating stage 310 and averagely distributed at the periphery of the heating stage 310 to support the edges of the substrate 360. The peripheral supporting mechanism 330 also can employ other structures as long as the edges of the substrate 360 can be stably supported.

The support pins 350 are averagely distributed on the surface of the heating stage 310 and can be manufactured by mineral material or organic material to support the substrate 360 at the start and the end of heating. The support pins 350 is raised and lowered by the elevator mechanism.

The appearance of the drying device of the present invention can utilize an opened design or a closed design. For a closed design, the heating stage, the peripheral supporting mechanism, the support pins and etc. are sealed in a chamber. The chamber is installed with a shutter. As the robot is picking and placing substrate 360, the shutter is opened. As the substrate is being dried, the shutter is in close status.

In other specific embodiment of the present invention, in case that the closed design is utilized, an exhaust unit can be installed in advance for guaranteeing the temperature and the pressure inside the chamber. The exhaust direction can be upward or downward. The location of the exhaust unit can be designed according to specific demand. The displacement of the exhaust unit is adjustable. The operation of the exhaust unit can be intermittently or constantly executed.

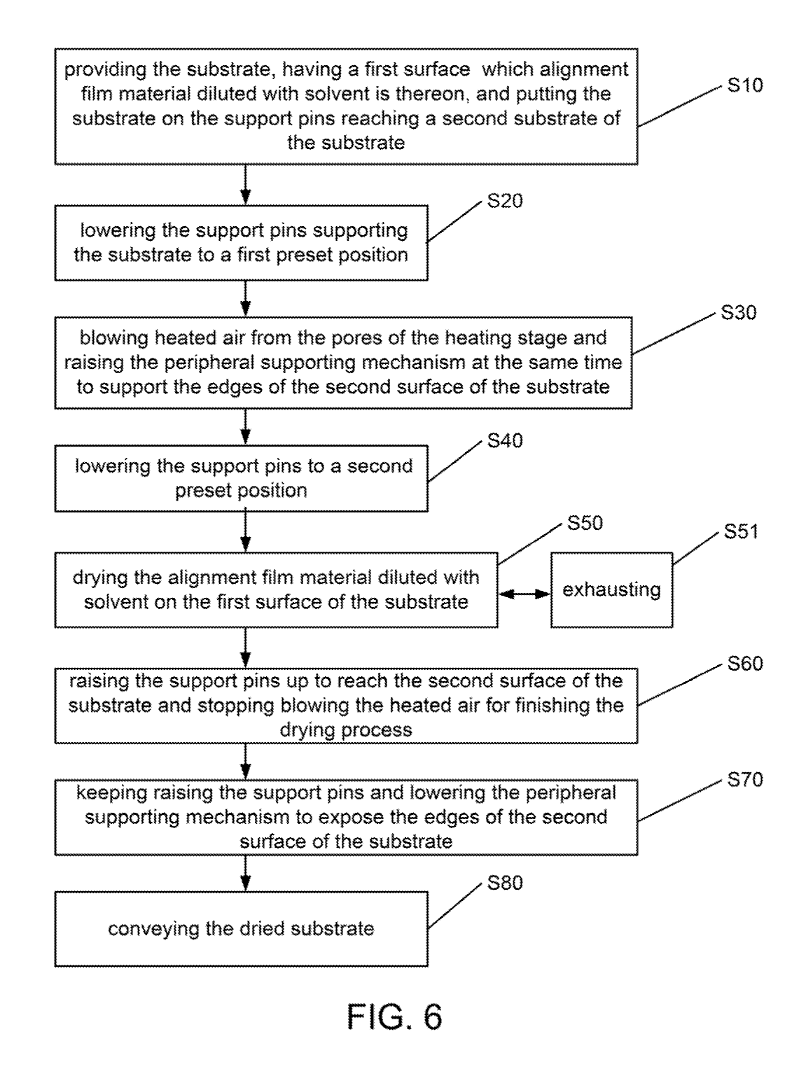

Please refer to FIG. 6, which shows a flowchart of the specific embodiment of the present invention. As the aforesaid alignment film drying device is utilized for drying the alignment film, the alignment film drying method comprises steps below:

Step S10, providing the substrate 360, having a first surface 360a which alignment film material diluted with solvent is thereon, and putting the substrate 360 on the support pins 350 reaching a second substrate 360b of the substrate 360.

Step S20, lowering the support pins 350 supporting the substrate 360 to a first preset position for the heating stage 310 to transmit the heat to the second substrate 360b of the substrate 360. In this specific embodiment, the spacing between the support pins 350 and the heating stage 360 is 2˜7 mm as the support pins 350 are at the first preset position.

Step S30, blowing heated air from the pores 311a of the heating stage 310 and raising the peripheral supporting mechanism 330 at the same time to support the edges of the second surface 360b of the substrate 360 with the supporting claws 340.

Step S40, lowering the support pins 350 to a second preset position. In this specific embodiment, the spacing between the support pins 350 and the heating stage 310 is 1˜7 mm as the support pins 350 are at the second preset position.

Step S50, drying the alignment film material on the first surface 360a of the substrate 360 with heat radiation of the heating stage 310 and the heated air blown out from the pores 311a. In this step, a time of drying the alignment film material is 1˜3 min and the temperature of the heating stage surface and the heated air flow maintain 80˜150 degrees C.

Step S60, raising the support pins 350 up to reach the second surface 360b of the substrate 360 and stopping blowing the heated air for finishing the drying process.

In one embodiment of the present invention, after Step S60, the alignment film drying method further comprises a step of:

Step S70, keeping raising the support pins 350 and lowering the peripheral supporting mechanism 330 to expose the edges of the second surface 360b of the substrate 360; and

Step S80, conveying the dried substrate 360.

In one embodiment of the present invention, the alignment film drying method further comprises a step of exhausting Step S51. The exhausting Step S51 is intermittently or constantly executed in Step S50.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. An alignment film drying device, used for drying alignment film material, which is diluted with solvent and formed on a first surface of a substrate, wherein the alignment film drying device comprises:
a heating stage, heating a second surface of the substrate and comprising a plurality of pores averagely distributed thereon;
a peripheral supporting mechanism, being located at the periphery of the heating stage to support edges of the second surface;
a plurality of support pins, being averagely distributed on an upper surface of the heating stage; and
an elevator mechanism, raising and lowering the peripheral supporting mechanism and the support pins.

2. The alignment film drying device of claim 1, wherein the peripheral supporting mechanism comprises a plurality of supporting claws parallelly located to the heating stage and the peripheral supporting mechanism supports the edges of the second surface of the substrate with the supporting claws.

3. The alignment film drying device of claim 1, further comprising an exhaust unit, and upward or downward exhaust directions, an exhaust time and a displacement of the exhaust unit are adjustable.

4. The alignment film drying device of claim 1, wherein a pitch between adjacent pores is 1˜10 mm.

5. The alignment film drying device of claim 1, wherein the heating stage comprises a first heat-conducting layer, a first insulation layer, a heating layer and a second insulation layer from top to bottom in sequence.

6. The alignment film drying device of claim 5, wherein the pores are vertically opened in the first heat-conducting layer, and an air flow channel is formed in the interior of the first heat-conducting layer, and each of the pores is connected to the air flow channel.

7. The alignment film drying device of claim 5, wherein the heating stage further comprises a second heat-conducting layer and the second heat-conducting layer located under the second insulation layer.

8. The alignment film drying device of claim 5, wherein the first heat-conducting layer is an aluminum plate.

9. The alignment film drying device of claim 5, wherein the heating layer is divided into a certain number of different-temperature subareas, the number of the different-temperature subareas is larger than or equal to one.

10. The alignment film drying device of claim 5, wherein the first insulation layer and second insulation layer are utilizing insulation material and the insulation material comprises mica.

11. The alignment film drying device of claim 7, wherein the first heat-conducting and second heat-conducting layer are utilizing heat-conducting material, the heat-conducting material comprises aluminum.

12. The alignment film drying device of claim 7, wherein the surfaces of the first heat-conducting and the second heat-conducting layer are coated with black re-electrolyte material, and the black re-electrolyte material can transform the heat on the heating stage into infrared ray, and the infrared ray can be absorbed by the substrate and turns into heat for heating the substrate.

13. The alignment film drying device of claim 1, wherein the first surface of the substrate comprises display areas, and the alignment film material diluted with solvent is formed on the display areas, and the number of the display areas on each substrate is six.

14. An alignment film drying method, utilizing in the alignment film drying device of claim 1, comprising steps of:
(a) providing the substrate, having the first surface which alignment film material diluted with solvent is thereon, and putting the substrate on the support pins reaching the second substrate of the substrate;
(b) lowering the support pins supporting the substrate to a first preset position;
(c) blowing heated air from the pores of the heating stage and raising the peripheral supporting mechanism at the same time to support the edges of the second surface of the substrate;
(d) lowering the support pins to a second preset position;
(e) drying the alignment film material diluted with solvent on the first surface of the substrate; and
(f) raising the support pins up to reach the second surface of the substrate and stopping blowing the heated air from the pores for finishing the drying process.

15. The alignment film drying method of claim 14, further comprising a step of:
(g) keeping raising the support pins and lowering the peripheral supporting mechanism to expose the edges of the second surface of the substrate; and
(h) conveying the dried substrate.

16. The alignment film drying method of claim 14, wherein the spacing between the support pins and the heating stage is 2˜7 mm as the support pins are at the first preset position; the spacing between the support pins and the heating stage is 1˜7 mm as the support pins are at the second preset position.

17. The alignment film drying method of claim 14, wherein the pores of the heating stage blow heated air to make the substrate floated away from the support pins to minus the effect of the support pins as drying the alignment film in advance.

18. The alignment film drying method of claim 14, wherein a time of drying the alignment film material is 1˜3 min and a temperature of drying the alignment film material is 80˜150 degrees C. in step (e).

19. The alignment film drying method of claim 14, further comprising an exhausting step (i) which is intermittently or constantly executed in step (e).

20. The alignment film drying method of claim 14, wherein the alignment film material is polyimide.
